(19) United States
(12) Patent Application Publication
(10) Pub. No.: US 2003/0017337 A1
(43) Pub. Date: Jan. 23, 2003

(54) Porous fillers coated with polyalkene

(76) Inventor: Gabriele Benkner, Moers (DE)

Correspondence Address: FULBRIGHT & JAWORSKI, LLP, 666 FIFTH AVE, NEW YORK, NY, 10103-3198, US

(21) Appl. No.: 10/126,924

(22) Filed: Apr. 19, 2002

(30) Foreign Application Priority Data
Apr. 27, 2001 (DE) 101 20 821.9

(51) Int. Cl. B05D 1/36

(52) U.S. Cl. 428/407; 427/402

(57) ABSTRACT

Porous fillers that are coated with polyalkene (for example polyethylene), methods for the production thereof and the use thereof as packing material in HPLC or as carrier material on plates in thin-layer chromatography are described.

The invention relates to porous fillers coated with polyalkene, methods for the production thereof and the use thereof.

In high-performance column liquid chromatography (HPLC), so-called composite materials are increasingly used as packing materials. In this connection, inorganic packing materials are covered with layers of organic polymers in order to combine the favourable properties of the inorganic materials (pressure stability) with the favourable properties of the organic polymers (chemical stability).

Coverings of poly-(butadiene maleic acid) (PBDMA) on porous inorganic carrier materials are known (P. Kolla, J. Köhler, G. Schomburg; Chromatographia Vol. 23, No. 7, July 1987). The disadvantage of this technology is the great cost to produce, including a very high solvent-requirement ( at least 2 liters of solvent are required per 10 g of product for washing purposes).

Coatings of polybutadiene are also known (M. P. Rigney, T. P. Weber, P. W. Car, J. Chromatogr., 484, 273-291 (1989). The disadvantage is the comparatively long cross-linking time during the production of the coating, as well as the high cost of washing with solvents.

Furthermore, silane-styrene copolymers applied covalently onto SiO₂—, Al₂O₃— and ZrO₂-surfaces are known (A. Kurganov, V. Davankov, T. Isajeva, J. Chromatogr., 660 (1994) 97-111). The disadvantage of this covering is the instability with respect to flow-promoters that have a high pH-value.

An object of the invention is to overcome the disadvantages of the prior art and to provide fillers that are coated with an organic polymer and which are comparatively stable with respect to solvents and strong acids or alkalies (flow-promoters), can be produced comparatively easily and can be used as packing material in HPLC or as carrier material on plates in thin-layer chromatography. Since in HPLC, or often reverse phase thin-layer chromatography, hydrophobic (lipophilic) packing materials are desired, the coated filler that is sought is also to have a hydrophobic (lipophilic) coating. In addition, it is also to be as stable as possible under pressure in order to be able to withstand the pressures of up to 800 bar that prevail during the production of chromatography columns.

The object is achieved by means of porous fillers that are coated with polyalkene.

Surprisingly, it has been found that polyalkenes, although already existing as polymers, can be applied to porous fillers in a comparatively simple manner. Therefore, polymerization (if this is possible at all), or subsequent cross-linkage, need not be carried out on the filler surface (starting from the monomer).

Polyethylene, polypropylene, polybutene and polypentene are the preferred polyalkenes that are used. Polyethylene is particularly preferred. The molar masses M_{w} (average molar mass relative to the weight, weight average) of the polyalkenes used preferably amount to 1,000 to 200,000. Fillers with small pores tend to require polyalkenes that have smaller molar masses; for example with a pore size of 10 nm preferably polyalkenes that have a molar mass M_{w} up to a maximum of 5,000 are used.

Porous, inorganic oxides, such as all types of silicon oxides (for example silica gels), aluminium oxides, zirconium oxide or titanium dioxide, can be used as the fillers.

The fillers preferably have particle sizes of 2 to 200 μm, in particular, preferably, 3 to 100 μm. The pore sizes of the fillers preferably lie between 3 and 400 nm, in particular preferably between 10 and 300 nm.

The porous fillers in accordance with the invention that are coated with polyalkene can be produced in accordance wish the following methods:

1. The polyalkene is dissolved in an organic solvent. If applicable, the porous filler is dried, for example by azeotropic distillation. The dry filler is added to the solution of polyalkene in the solvent and uniformly distributed (for example by stirring). Subsequently, the solvent is evaporated to dryness, preferably whilst subject to stirring or rotation and particularly preferably under vacuum. What is obtained is the porous filler that is coated with the polyalkene.

1 The polyalkene is dissolved in an organic solvent. The dry, porous filler is added to this solution and uniformly distributed. Subsequently, the suspension is cooled to ambient temperature whilst subject to stirring or rotation. This cooling preferably takes place within 0.5 to 5 hours, particularly preferably 1 to 3 hours. The dissolved polyalkene then precipitates on the surface of the porous filler and thus a coating forms on the porous filler. This can be separated from the solution (for example by filtration) and, if applicable, purified and dried.

Hydrocarbons that have a boiling point of >60° C., preferably >70° C. and/or halogenated hydrocarbons that have a boiling point of >40° C. can preferably be used as organic solvents for the methods which have been described. Solvents that are particularly preferred are hexane, heptane, octane, cyclohexane, cycloheptane, benzene, toluene, xylene, cumene, tetralin, dichloromethane, dichloroethane, dichloropropane, dibromopropane and dibromopropane (sic). In order to dissolve the polyalkene in the organic solvent, the latter is preferably heated, in which case the maximum temperature depends upon the boiling point of the solvent, yet preferably should not exceed 180° C.

The quantity of polyalkene to be used is determined by the specific area of the porous filler to be coated and by the latter's pore size. A preferred polymer layer thickness is 0.5 to 5 nm. This means, for example, that, with a filler that has a specific area of 60 m²/g per 100 g filler, 2.4 to 24 g polymer having a density of 0.8 g/ml can be used. (100 g filler has an area of 6000 m²; given a polymer layer thickness of 0.5 nm, a volume of 3 ml polymer is required; given a polymer density of 0.8 g/ml, this corresponds to 2.4 g polymer).

Before coating with a polyalkene as described, the surface of the porous filler can be modified with the aid of a so-called primer (prime-coated). Substances which are suitable for making surfaces hydrophobic can be used as primers. Preferred primers are silanes, titanates, germanates, carboxylic acids with more than 2 C-atoms (preferably 10 to 18 C-atoms), organic sulphonic acids or orgaric phosphonic acids. Examples of primers are triethoxyvinyl silane, alkyl silanes (for example butyl silane, octyl silane, decyl silane, octadecyl silane), acrylic acid, methacrylic acid, lauric acid, stearic acid, butyl phosphonic acid, octyl phosphonic acid or octadecyl phosphonic acid. The surface modification can be effected as follows. The porous filler is dispersed in a solvent, which forces an azeotrope with water, and the desired quantity of primer is added. Subsequently, the solvent is completely evaporated whilst subject to stirring. In this connection, the primer chemically couples to the filler surface (for example esterification or transesterification on surface-stable OH-groups). The preferred maximum amount that is added is metered, for example, in such a way that each surface-stable OH-group of the filler (in the case of TiO₂ approximately 10 OH groups per nm²) could be esterified, that is for example, per 100 g TiO₂ having a specific area of 60 m²/g up to a maximum of 0.1 mol primer is preferably used. Depending on the molecule size of the primer, however, for steric reasons it is not always possible to reach all the OH-groups. Surplus primer can be rinsed off, for example, with a solvent, in which the primer is soluble, in a filtering apparatus. Drying and the described polyalkene-coating follow after this method step.

The porous fillers that are coated with polyalkene are used in chromatography, for example as packing material in liquid chromatography (such as HPLC) or as carrier material on plates in thin-layer chromatography.

The fillers in accordance with the invention have the advantage of being comparatively simple to produce, of having good stability with respect to alkalies and pressure, and thus of being suitable in an outstanding manner in reverse phase chromatography, particularly HPLC.

The invention is explained in greater detail in the following with reference to examples.

### EXAMPLE 1

### Coating Titanium Dioxide with Polyethylene

1.5 g of polyethylene having a M_{w} of approximately 4000 were added to 150 ml toluene and boiled in a 1-1-three-necked flask having an intensive cooler and high-speed stirring mechanism under reflux until completely dissolved. 30 g of dried, porous titanium dioxide having an average particle size of 5 μm and an average pore diameter of 10 nm were added to the solution. The preparation was boiled for 15 minutes and at the same time stirred at 500 rpm. The heating was then switched off and the stirring continued at the same speed until the temperature had cooled to ambient temperature. The solid was subsequently filtered off, washed with 50 ml acetone and dried.

The product thus obtained had a carbon content of 3.5% by weight. Further properties follow from the details given below:

| Physical data of | | | | |
|---|---|---|---|---|
| the titanium | | | | |
| dioxide | before coating | | after coating | |
| Specific area | 55 | m²/g | 28 | m²/g |
| Pore volume | 0.18 | ml/g | 0.10 | ml/g |
| Pore diameter | 10 | nm | 9.6 | nm |

### EXAMPLE 2

### Coating Titanium Dioxide with Polyethylene

1.5 g of polyethylene having a M_{w} of approximately 4000 were added to 150 ml toluene and boiled in a 1-1-three-necked flask having an intensive cooler, distillation bridge and high-speed stirring mechanism under reflux until completely dissolved. 30 g of dried, porous titanium dioxide having an average particle size of 5 μm and an average pore diameter of 10 nm was added to the solution. Subsequently, the solvent was distilled off to complete dryness. At the same time stirring was carried out at 500 rpm.

The product thus obtained had a carbon content of 3.1% by weight. Further properties follow from the details given below:

| Physical data of | | | | |
|---|---|---|---|---|
| the titanium | | | | |
| dioxide | before coating | | after coating | |
| Specific area | 55 | m²/g | 29 | m²/g |
| Pore volume | 0.18 | ml/g | 0.12 | ml/g |
| Pore diameter | 10 | nm | 9.6 | nm |

### EXAMPLE 3

### Coating Titanium Dioxide, Modified by Octyl Phosphonic Acid, with Polyethylene

0.15 g of octyl phosphonic acid (primer) was dissolved in 40 ml toluene. To this were added 10 g of dried, porous titanium dioxide having an average particle size of 5 μm and an average pore diameter of 10 nm. The solvent was removed under normal pressure on a rotary evaporator. The residue was then added to a 120° C. hot solution of 0.5 g polyethylene, having a M_{w} of approximately 5000, in 80 ml xylene and then dried by a rotary evaporator at a bath temperature of 140° C.

The product thus obtained had a carbon content of 5.4%.

Further properties follow from the details given below:

| Physical data of | | | | |
|---|---|---|---|---|
| the titanium | | | | |
| dioxide | before coating | | after coating | |
| Specific area | 55 | m²/g | 25 | m²/g |
| Pore volume | 0.18 | ml/g | 0.09 | ml/g |
| Pore diameter | 10 | nm | 9.5 | nm |

### EXAMPLE 4

### Liquid Chromatography with a Coated, Porous Filler According to Example 1

3.6 g of a coated, porous filler (produced according to the filtration method in accordance with Example 1) was shaken into 37 ml isopropanol and by means of a standard filling arrangement fed into an HPLC column (4 mm×150 mm). Immediately after the apparatus had been closed, 230 ml isopropanol were flushed through from above at 600 to 700 bar liquid pressure. A dense packing of the filling material thereby formed in the column.

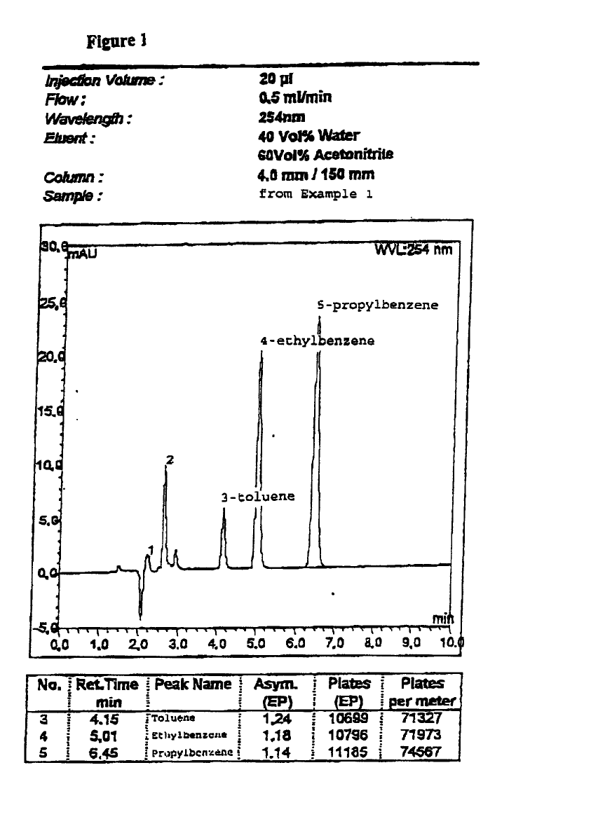

20 μl of a sample, consisting of a mixture of toluene, ethylbenzene and propylbenzene, dissolved in acetonitrile and water, was chromatographed with this column. The result is reproduced in FIG. 1.

### EXAMPLE 5

### Liquid Chromatography with a Coated, Porous Filler According to Example 2

3.6 g of a coated, porous filler (produced according to the drying method in accordance with Example 2) were shaken into 37 ml isopropanol and by means of a standard filling arrangement fed into an HPLC column (4 mm×150 mm). Immediately after the apparatus had been closed, 250 ml isopropanol were flushed through from above at 600 to 700 bar liquid pressure. A dense packing of the filling material thereby formed in the column.

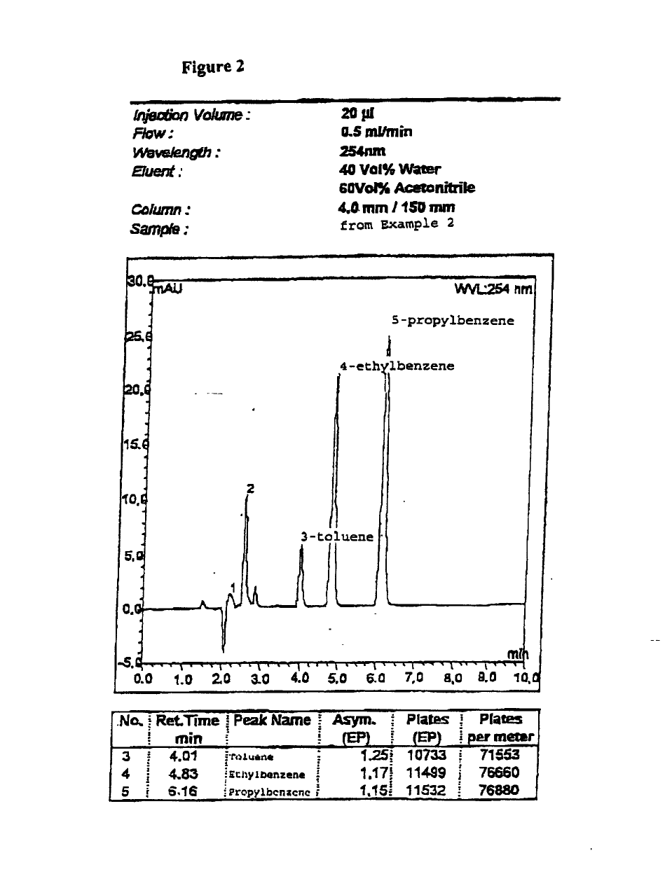

20 μl of a sample, consisting of a mixture of toluene, ethylbenzene and propylbenzene, dissolved in acetonitrile and water, were chromatographed with this column. The result is reproduced in FIG. 2.

### EXAMPLE 6

### Liquid Chromatography with a Coated, Porous Filler According to Example 3

3.6 g of a costed, porous filler (produced with a primer in accordance with Example 3) were shaken into 37 ml isopropanol and by means of a standard filling arrangement fed into an HPLC column (4 mm×150 mm). Immediately after the apparatus had been closed, 250 ml isopropanol were flushed through from above at 600 to 700 bar liquid pressure. A dense packing of the filling material thereby formed in the column.

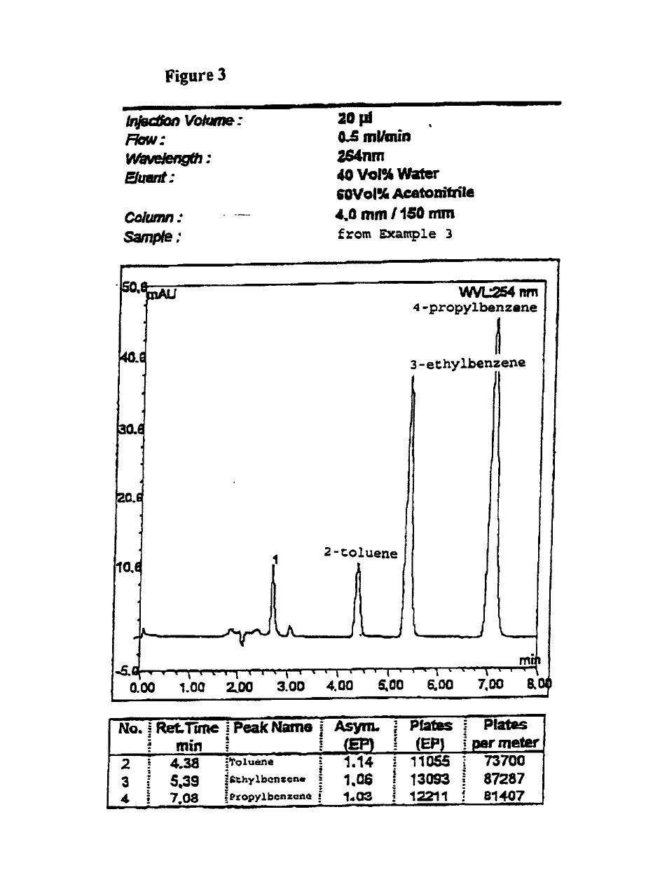

2 μl of a sample, consisting of a mixture of toluene, ethylbenzene and propylbenzene, dissolved in acetonitrile and water, were chromatographed with this column. The result is reproduced in FIG. 3.

### EXAMPLE 7

### Treatment of the column from Example 5 with NaOH

The column from Example 5 was flushed, after 20 injections of various test mixtures, with a flow of 20 ml/minute in each case, with 1 molar NaOH for 30 minutes, then with 1% acetic acid for 10 minutes and subsequently with a mixture of 60% by volume acetonitrile and 40% by volume water for 10 minutes.

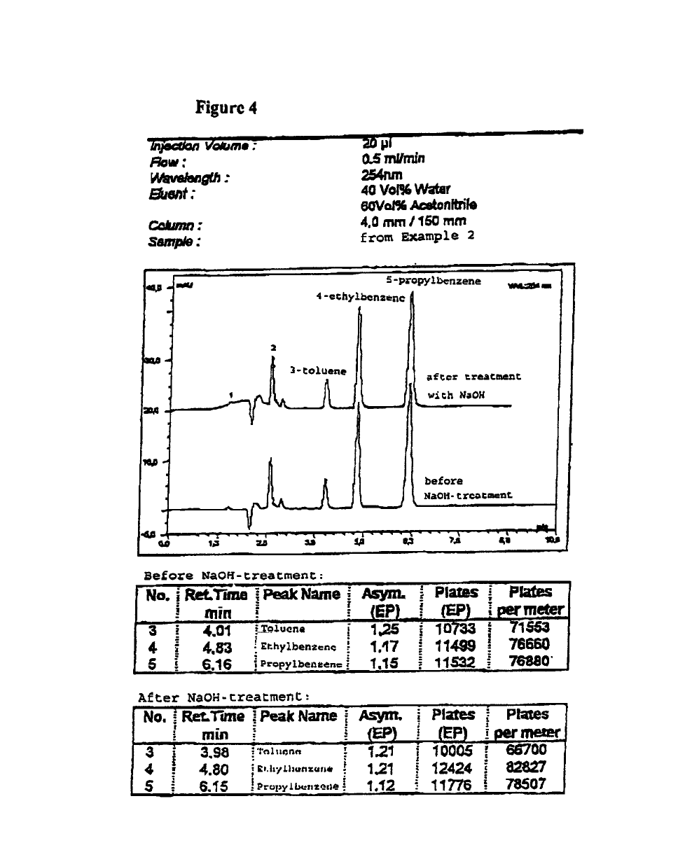

After this treatment, the separation of the alkyl benzenes was repeated in a manner analogous with Example 5. The result is reproduced in FIG. 4 (upper curve). For the purposes of comparison, the chromatogram before treatment (Example 5) is indicated again in the lower curve. It appeared that the column had suffered no damage as a result of the NaOH-treatment and the quality of the column had remained the same.

FIG. 1

Example 4

from Example 1

5-propylbenzene

4-ethylbenzene

3-toluene

Toluene

Ethylbenzene

Propylbenzene

FIG. 2

Example 5

from Example 2

5-propylbenzene

4-ethylbenzene

3-toluene

Toluene

Ethylbenzene

Propylbenzene

FIG. 3

Example 6

from Example 3

4-propylbenzene

3-ethylbenzene

2-toluene

Toluene

Ethylbenzene

Propylbenzene

FIG. 4

Example 7

from Example 2

5-propylbenzene

4-ethylbenzene

3-toluene

after treatment with NaOH

before NaOH-treatment

Before NaOH-treatment:

Toluene

Ethylbenzene

Propylbenzene

After NaOH-treatment:

Toluene

Ethylbenzene

Propylbenzene

1. Porous fillers coated with polyalkene.

2. Fillers according to claim 1, characterized in that polyethylene, polypropylene, polybutylene or polypentene is used as the polyalkene.

3. Fillers according to claim 1 or 2, characterized in that silicon oxides (for example silica gels), aluminium oxides, zirconium oxide or titanium dioxide is/are used as the porous fillers.

4. Fillers according to one of claims 1 to 3, characterized in that the polymer layer thickness amounts to 0.5 to 5 nm.

5. Method for producing porous fillers coated with polyalkene, characterized in that the polyalkene is dissolved in an organic solvent, a dry, porous filler is added to this solution, and the solvent is evaporated to dryness.

6. Method for producing porous fillers coated with polyalkene, characterized in that the polyalkene is dissolved in an organic solvent, a dry, porous filler is added to this solution, and the solution that is obtained is cooled, with the dissolved polyalkene precipitating onto the surface of the porous filler.

7. Method according to one of claims 5 or 6, characterized in that hydrocarbons having a boiling point of >60° C. and/or halogenated hydrocarbons having a boiling point of >40° C. are used as organic solvents.

8. Method according to claim 7, characterized in that one or more of the compounds hexane, heptane, octane, cyclopentane, cyclohexane, cycloheptane, benzene, toluene, xylene, cumene, tetralin, dichloromethane, dichloroethane, dichloropropane, dibromopropane or dibromopropane (sic) is used as the solvent.

9. Method according to one of claims 5 to 8, characterized in that the organic solvent for dissolving the polyalkene is heated to a maximum of 180° C.

10. Method according to one of claims 5 to 9, characterized in that the quantity of polyalkene that is to be used is metered in such a way that a polymer layer thickness of 0.5 to 5 nm is applied to the surface of the porous filler.

11. Method according to one of claims 5 to 10, characterized in that the surface of the porous filler is modified with a primer (prime-coated) and subsequently coated with a polyalkene.

12. Method according to claim 11, characterized in that substances which are suitable for making surfaces hydrophobic, such as silanes, titanates, germanates, carboxylic acids with more than 2 C-atoms, organic sulphonic acids or organic phosphonic acids, are used as primers.

13. Method according to one of claims 11 or 12, characterized in that in order to modify the surface of the porous filler, the latter is dispersed in a solvent, which forms an azeotrope with water, and the primer is added, and the solvent is subsequently completely evaporated.

14. Use of the porous fillers that are coated with polyalkene in chromatography, for example as packing material in liquid chromatography (such as HPLC) or as carrier material on plates in thin-layer chromatography.
